(19) United States
(12) Patent Application Publication
(10) Pub. No.: US 2010/0271218 A1
(43) Pub. Date: Oct. 28, 2010

(54) INFUSION TRACKING SYSTEM

(75) Inventors: Robert E. HOAG, San Diego, CA (US); Joseph Condurso, Olivernhain, CA (US); Conny Johnson, Lakeside, CA (US); Wayne Johnson, Lakeside, CA (US)

Correspondence Address: McDermott Will & Emery LLP, 11682 EL CAMINO REAL, SUITE 400, SAN DIEGO, CA, 92130-2047, US

(73) Assignee: CAREFUSION 303, INC., San Diego, CA (US)

(21) Appl. No.: 12/764,884

(22) Filed: Apr. 21, 2010

Related U.S. Application Data
(60) Provisional application No. 61/172,174, filed on Apr. 23, 2009.

(51) Int. Cl. G08B 21/00

(52) U.S. Cl. 340/606; 358/1.15

(57) ABSTRACT

A fluid medication delivery monitoring device is disclosed. The device includes a memory configured to receive volume information indicating a volume of fluid medication in a container. The device also includes a processor configured to determine a time remaining value indicating an approximate amount of time remaining until the dispensable volume of fluid medication in the container reaches about zero, and configured to compare the determined time remaining value to a lead-time threshold to prepare a replacement container with a volume of fluid medication. The device further includes a display device configured to display a status of the container, the status includes the time remaining value and a description of the fluid medication in the container. A method for monitoring fluid medication delivery is also disclosed.

### CROSS-REFERENCE TO RELATED APPLICATIONS

This application claims priority to U.S. Provisional Patent App. No. 61/172,174, filed on Apr. 23, 2009, the entire contents of which are herein incorporated by reference

### BACKGROUND

The present disclosure generally relates to management of infusion medications, and more particularly, to a system for monitoring infusion medications and for automatically alerting a need for replenishment medication.

### DESCRIPTION OF THE RELATED ART

Many individuals suffer from chronic health problems, the treatment of which requires regular, and sometimes extended, medication deliveries. Certain treatment regimens for diseases such as diabetes, asthma, epilepsy, cancer and even allergies, require the regular and sequence delivery of precise amounts of medication for the patient's survival. Treating chronic medical disorders often requires the administration of medication over a long period of time according to a treatment regimen specified by a medical professional, such as a physician.

In cases of patients admitted to a healthcare facility, one or more infusions to be administered to a patient are prescribed by the patient's physician. A pharmacy, generally located within the patient's hospital or healthcare facility, prepares the infusion medication or solution according to the physician's prescription. The pharmacist places the infusion solution in a bag, bottle, syringe, or other container and labels the container. The label typically contains data to identify the patient, physician, medication prescribed, and a control number. The label is generally typed or printed in human readable characters and may also include machine-readable information, such as a bar code that is readable by optical energy or a radio frequency identification (RFID) tag that is readable by radio frequency (RF) energy. The container is transported to the patient's location and a clinician such as a nurse or other health practitioner hangs the container from a rack. The nurse connects a tube between the container and an infusion pumping system and inserts a cannula at the end of the tube into the vessel of the patient. The infusion pump is started and the infusion proceeds.

There exist intravenous infusion pumping systems capable of administering multiple infusates at individually programmable rates, volumes, and sequences. Such pump systems increase the ability to administer complex programs of infusion therapies and reduce the time and labor required by nurses or other health practitioners in setting up and monitoring infusions while improving the reliability of proper infusion.

Infusion pumps are highly sophisticated and, depending on the type, can communicate wirelessly or by wired means with various servers and hospital information systems (“HIS”) according to how they are programmed. Through the HIS or other data communication systems, the infusion pump can communicate with various healthcare facility servers or processors, including patient admission databases, laboratories having databases of patient laboratory results, nurse stations, and the pharmacy or pharmacies, whether it is a central pharmacy or one of many smaller pharmacies in a healthcare facility.

The clinician either enters the programming data regarding the infusion into the pumping system manually, or the pumping system automatically loads the programming data from the label on the medication container or through a wired or wireless connection to another data source. The programming data may include, for example, the rate of infusion, the total volume to be infused, and in some cases, other delivery or operational parameters.

The clinician starts the infusion and then performs a periodic monitoring of the patient and infusion according to the standard healthcare facility procedures. The pump will infuse the medication until it reaches the target volume to be infused, or until the pump empties the container. If the clinician notes that the present medication container is about to be depleted, a replenishment container of the same medication could be ordered from the pharmacy, if so prescribed. Ideally, the new container would be delivered shortly prior to depletion of the present medication container, then upon actual depletion, the clinician would replace the emptied container with the new container, start the pump again, and the patient would continue to receive the prescribed medication with a very short interruption.

However, if the clinician does not detect the depletion of the contents of the container prior to the pump stopping, the patient may be without replenishment medication for some time since the pharmacy must be contacted to order more, the pharmacy must verify that a prescription exists for the additional medication, and then the pharmacy must prepare and deliver another container to the patient location. This latter situation may occur since clinicians are busy and do not have the time to continually check on each patient. When a pump alarm sounds to indicate that the container has been emptied of medication, the attention of the clinician may then be focused on obtaining replenishment medication. As used herein, “replenishment” may refer to replacing the depleted medication container with a container of the same medication or with a different medication. Use of the term “replenishment” is not to be construed as being limited to the same medication.

The physician's prescription may call for one medication followed by another medication or may prescribe an infusion of a volume of a single medication that is too large to fit into a single container and therefore multiple containers must be used. While the pharmacy may be able to prepare the entire prescription of multiple containers of medication at one time, this is generally not done where there would be a significant time period or periods between infusion of one container and another. In some cases, the medication prescribed is expensive and is therefore not prepared far in advance. In another case, the medication is not stable enough to be prepared far in advance.

In the typical manual method, the clinician enters each patient's room for the purpose of checking the status of the patient's infusions. Should the clinician note that a particular medication is near the end of infusion and the replenishment process should begin, the clinician will communicate to the pharmacy to order the next intravenous (IV) container. An increase in the number of patients requiring medical treatment, nursing staff shortages, and poorly designed healthcare facilities can contribute to inadequate patient monitoring or delayed monitoring. In some medical care facilities, alarms generated by patient monitoring and/or diagnostic devices may go unnoticed because of the remote location of the patient's room or because of inadequate sound generated by the patient monitoring and/or diagnostic devices. Providing an ability to more carefully automatically monitor patients and their infusions would provide an advantage.

### SUMMARY

It would be a valuable improvement in the art if a system or device were able to determine when the patient's present supply of medication would be depleted and inform the pharmacy of the predicted time of depletion. It would also be valuable if a system or device were able to determine if another medication is to follow the one being depleted, and if so, to determine a lead-time for preparation of the subsequent medication, and inform the pharmacy that replenishment of medication is needed. It would also be valuable to provide the ability for pharmacy personnel to not only see the progress of infusions occurring throughout the healthcare facility, but also permit the distributional pharmacist to view an infusion status of the patient location to which the admixture of the next bag must be delivered.

Hence, there exists a need for a system and method that can alert a pharmacy to an imminent depletion of a patient's infusion medication, and that can provide a sufficient lead-time for preparation of the next container of medication. There also exists a need for a more sophisticated system and method that can automatically verify that a prescription exists for continued medication and can communicate a priority message to the pharmacy for replenishment of that medication. A need also exists for a more automated process in which approval of the preparation of additional medication can be obtained more rapidly so that unnecessary delays in patient infusions are avoided. The present disclosure fulfills these needs and others.

Briefly and in general terms, the present disclosure is directed to a system and a method for monitoring a patient's present infusion status and automatically alerting a pharmacy in a healthcare facility of the need to replenish the medication prior to the need for delivery of the next medication to the patient to begin. In accordance with an aspect of the fluid monitoring device of the present disclosure, the status of a patient's present infusion is monitored, the end of delivery is determined and the pharmacy alerted to begin preparation of a medication so that delivery to the patient location of that new medication container can occur before the end of infusion of the present medication container.

According to certain embodiments of the present disclosure, a fluid medication delivery monitoring device is provided. The device includes a memory configured to receive volume information indicating a volume of fluid medication in a container. The device also includes a processor configured to determine a time remaining value indicating an approximate amount of time remaining until the dispensable volume of fluid medication in the container reaches about zero, and configured to compare the determined time remaining value to a lead-time threshold to prepare a replacement container with a volume of fluid medication. The device further includes a display device configured to display a status of the container, the status includes the time remaining value and a description of the fluid medication in the container.

According to certain aspects of the present disclosure, a method for monitoring fluid medication delivery is provided. The method includes receiving volume information indicating a dispensable volume of fluid medication in a container, and determining a time remaining value indicating an approximate amount of time remaining until the volume of fluid medication in the container reaches about zero. The method also includes comparing the determined time remaining value to a lead-time threshold to prepare a replacement container with a volume of fluid medication, and displaying a status of the container, the status includes the time remaining value and a description of the fluid medication in the container.

According to certain embodiments of the present disclosure, a fluid medication delivery monitoring device is provided. The device includes a memory configured to receive volume information indicating a volume of fluid medication in a container. The device also includes a processor configured to determine a time remaining value indicating an approximate amount of time remaining until the dispensable volume of fluid medication in the container reaches about zero, and configured to compare the determined time remaining value to a lead-time threshold to prepare a replacement container with a volume of fluid medication. The device further includes a display device configured to display a status of the container, the status includes the time remaining value and a description of the fluid medication in the container, and an output device configured to generate a print command configured to cause a printer to generate a medication label, and further configured to generate an alert indicating a need for the replacement of the container within the lead-time threshold.

These and other aspects, features, and advantages of the present disclosure will become apparent from the following detailed description of the preferred embodiments which, taken in conjunction with the accompanying drawings, illustrate by way of example the principles of the disclosure.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a modular infusion system according to certain embodiments.

FIG. 2 is a block diagram of the modular infusion system of FIG. 1.

FIGS. 3A-3B are sample screenshots of medication status interfaces according to certain embodiments.

FIGS. 4A-4C are sample screenshots of patient information interfaces according to certain embodiments.

FIG. 5 is a sample screenshot of a nurse station interface according to certain embodiments.

### DETAILED DESCRIPTION

In the following detailed description, numerous specific details are set forth to provide a full understanding of the present disclosure. It will be obvious, however, to one ordinarily skilled in the art that the embodiments of the present disclosure may be practiced without some of these specific details. In other instances, well-known structures and techniques have not been shown in detail not to obscure the disclosure.

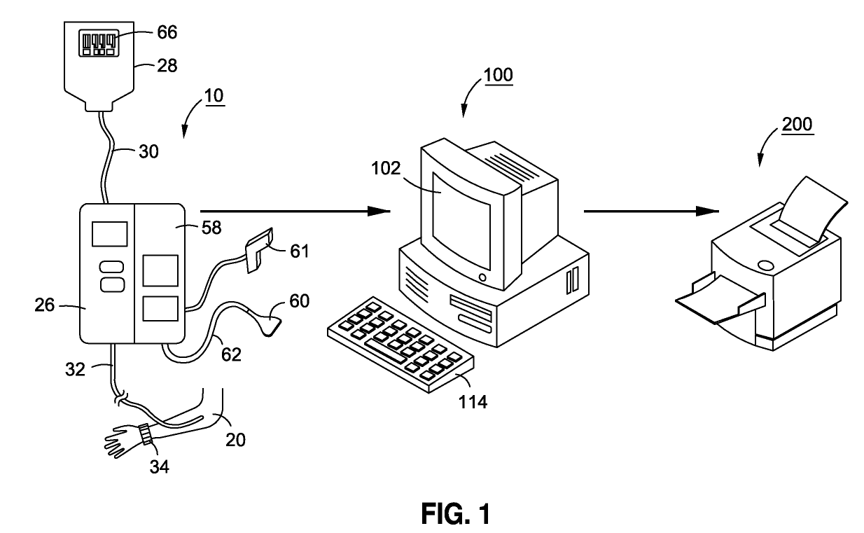

Referring now to the drawings in more detail in which like reference numerals refer to like or corresponding devices among the views, there is shown in FIG. 1 a point of care unit (PCU) 10, fluid monitoring device 100, and printer 200 according to certain embodiments.

The PCU 10 includes an IV infusion pump 26 and a data reader module 58 for infusing a medication supplied from a hanging medication container 28 through an upper fluid administration line 30 and a lower fluid administration line 32 into a patient 20. In certain embodiments, the PCU 10 is similar to that described in U.S. Pat. No. 5,713,856 to Eggers et al., which is incorporated herein by reference. Alternatively, other patient care devices, such as pumps, physiological monitors (e.g., heart rate, blood pressure, ECG, EEG, pulse oximeter, and other patient monitors), therapy devices, and other drug delivery devices may be utilized according to the teachings set forth herein.

The data reader module 58 is configured to read bar codes or other information on medication containers with a reader 60 tethered to the module 58 with a wired connection 62. In certain embodiments, a wireless connection can be used instead of wired connection 62. The data reader module 58 is also configured, in certain embodiments, to read RFID tags on medication containers with a built-in RFID interrogator or RFID reader 61, such as RFID tag label 66 on medication container 28 or a wristband identification tag 34 worn by the patient 20. A data input device other than the bar code reader 60 or RFID reader 61 could be used, such as any device for entering coded data into a computer, such as devices for reading magnetic strips, PCMCIA smart cards, radio frequency cards, memory sticks, CDs, DVDs, or any other analog or digital storage media. Other examples of data input devices include a voice activation or recognition device or a portable personal data assistant (PDA). Additional devices that can be used to identify medication can be found in U.S. Patent Application Publication No. 2006/0229551, which is hereby incorporated herein by reference in its entirety.

The identifier associated with the patient's identification tag 34 and the identifier associated with the RFID tag label 66 allow the PCU 10 to retrieve information associated with the patient 20 (hereinafter “patient information 22”) and the medication container 28 (hereinafter “medication container information 24”) by referencing the identifiers in a database or other information source that stores the patient information 22 and the medication container information 24. For example, in certain embodiments, label 66 includes information concerning the contents of the medication container 28. Included in that information is the initial volume of medication in the medication container 28. The PCU 10 obtains that volume information either by manual input or by scanning the bar code 66 of the container 28 with the bar code reader 60, or by other means. By any of a number of various methods, the PCU 10 is able to determine the amount of medication remaining to be delivered by the infusion pump 26 during the patient's infusion. The PCU 10 also receives the desired rate of delivery of the medication from reading the label 66 or from manual input as described above and is therefore able to determine the time remaining before the amount of the medication is completely delivered. These determinations by the PCU 10 are readily available, and may be communicated to other devices, such as to the fluid monitoring device 100, as described below.

The patient information 22 that is determined by the PCU 10 can include, for example, a patient name, room number or location, identification number, date of birth, bed identifier, height, weight, lists of medications taken or to be taken, associated healthcare providers, allergies, current lab values, vital sign variables being monitored, patient identification number, patient record number, federal identification number, and social security number. The medication container information 24 determined by the PCU 10 can include, for example, a name of a drug in the medication container 28, its concentration, its contraindications, order identification, an associated lab test used to routinely measure therapeutic progress or toxic levels of the medication being described, its cumulative dosing, its twenty-four hour dose rate history, its dose rate, its historical dose rate, its volume rate, its volume remaining, and its status. In certain embodiments, the patient information 22 and/or the medication container information 24 are independently and manually provided, removed, or otherwise edited by a user at the PCU 10. In certain embodiments, patient information 22 and medication container information 24 are retrieved from a server, such as a centralized hospital database that contains patient and medication information, e.g., a medical library database, an alert-discharge-transfer (ADT) system, etc.

The infusion pump 26 of the PCU 10 is configured to provide a value indicating the volume of medication fluid in the medication container 28 and the rate of delivery of the medication fluid in the medication container 28 to the patient 20, which is also included in the medication container information 24. The infusion pump 26 is capable of being programmed for controlling and monitoring the infusion of the medication fluid to the patient 20.

The fluid monitoring device 100 is configured to process and display, on a display device 102, the status (e.g., ongoing infusion progress) of the infusion pump 26, and is also configured to determine the time remaining in the infusion of the medication container 28. The fluid monitoring device 100 may then instruct a printer 200 to print a label for another medication container 28 to replace a depleted medication container 28, if necessary, such that a nearby user, such as a pharmacist, will thereby be prompted by the printing of the label to prepare a replacement medication container 28. The fluid monitoring device 100 is also configured to receive input from an input device 114. In accordance with aspects of the disclosure, this arrangement will provide pharmacists and nurses with the ability to view the status of the infusion of the medication container 28 of FIG. 1 and other medication containers (not illustrated) occurring in a healthcare facility without being at the bedside of the patients. The fluid monitoring device 100 will identify medication container 28 infusions that are nearly completed and notify the pharmacist or other healthcare professional of the need to anticipate the admixture (preparation) of a next infusion.

The fluid monitoring device 100 as disclosed herein can be used in acute care hospitals where patients are being administered medication via infusion, such as IV infusions. The fluid monitoring device 100, and/or at least the display device 102 of the fluid monitoring device 100, may be located in any number of locations, such as a nurse station or a pharmacy. The pharmacy may be located remotely from the patient 20, or in other cases, may be quite near to the patient. The nurse station is meant to be near to the patient 20. Both the pharmacy and nurse station may comprise more than one physical location. While there may be a central pharmacy and a central nurse station in the particular healthcare facility, there may also be satellite pharmacies and multiple nurse stations, in larger facilities. Some of these may be closer to the patient 20 than others.

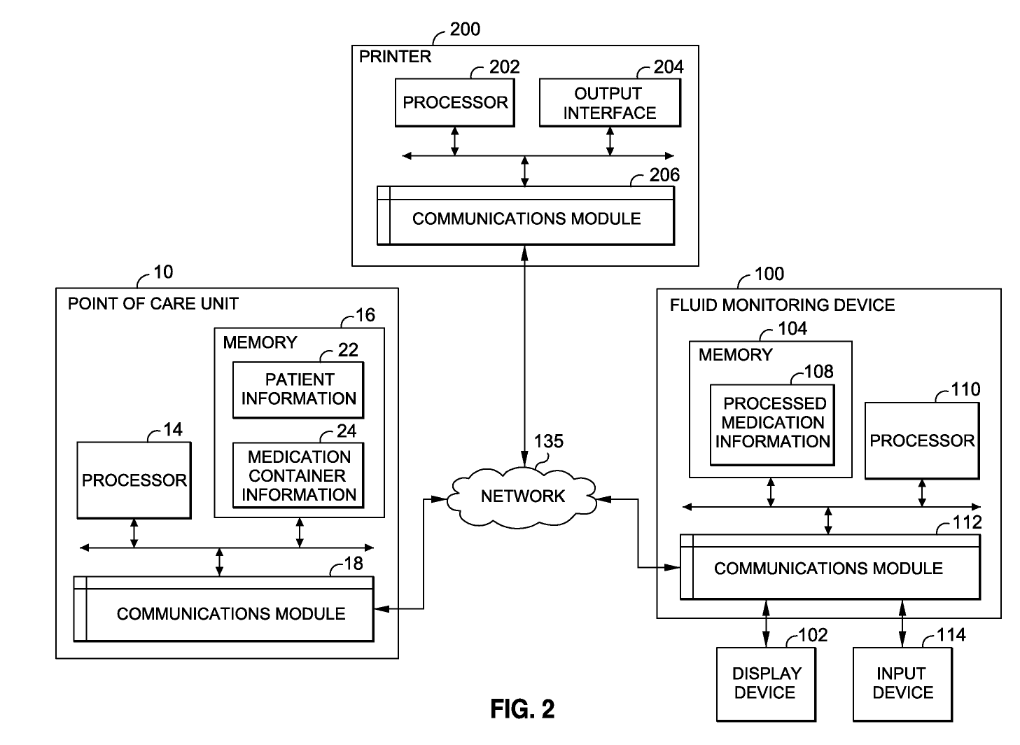

FIG. 2 is a block diagram of the modular infusion system of FIG. 1. The fluid monitoring device 100 obtains the patient information 22 and the medication container information 24 discussed above over a network 135 from a memory 16 in the PCU 10. The network 135 can be, for example, a local area network operated by the healthcare facility, or a wide area network, such as the Internet. Connections to the network 135 may be wired or wireless. The transmission channel for connections to the network 135 may comprise any wired or wireless transmission channel, for example an 802.11 wireless local area network (LAN). Network connections can be direct network connections, such as a T1 connection, an integrated services digital network (ISDN) connection, a digital subscriber line (DSL) modem, or a cable modem. Any direct or indirect network connection may be used, including, but not limited to a telephone modem, an MIB system, an RS232 interface, an auxiliary interface, an optical link, an infrared link, a radio frequency link, a microwave link or a WLANS connection or other wireless connection.

The patient information 22 and medication container information 24 is transmitted from the PCU 10 via a communications module 18, such as a modem or network access card, over the network 135, and to a communications module 18 of the fluid monitoring device 100, where it is stored in memory 104. By referencing the medication container information 24, which includes volume information indicating a volume of fluid in the medication container 28, and rate information indicating a rate of reduction of the volume of fluid in the medication container 28, the processor 110 determines a time remaining value indicating an approximate amount of time remaining until the volume of fluid in the container reaches about zero, and compares the determined time remaining value to a lead-time threshold. This information is stored as processed medication information 108 in the memory 104 of the fluid monitoring device.

The processor 110 of the fluid monitoring device 100 is configured to provide instructions to the printer 200 to print a label 66 for a medication container 28, such as for a medication container 28 to replace an empty medication container 28 at the PCU 10. For example, should the processor 110 determine that a replenishment medication container 28 is needed, it may communicate instructions to print a label via its communications module 112, over the network 135, to the communications module 206 of the printer 200, and the processor 202 of the printer may then instruct the output interface 204 to physically print the label 66. Personnel near the printer 200, such as healthcare professionals in the pharmacy, would notice the label and begin preparation of the replacement medication container 28. Alternatively, or additionally, an alert may be issued in some manner to the healthcare professionals in the pharmacy, alerting them to the need to begin preparation of the replacement medication container 28. The label 66 is printed in parallel to the alert.

The processor 110 of the fluid monitoring device 100 is also configured to provide the processed medication information 108 to the display device 102, and receive input from the input device 114. The display device 102, for example, a monitor, is configured to display, for example, a status of the medication container 28, a status comprising the time remaining value and a description of the fluid in the medication container 28, and an alert if the determined time remaining value is less than or about equal to the lead-time threshold. In certain embodiments, the input device 114 is a keyboard, but in certain embodiments, the input device could include any means for inputting information, such as a touch screen, soft keys, a mouse, a track ball, and/or a light pen.

The fluid monitoring device 100 is configured to issue an alert, via communications module 112, to a clinician or other healthcare professional to their pager or other personal device when the infusion of the medication in the medication container 28 is nearly diffused (e.g., the medication container 28 is nearly empty). Specifically, when the medication in the medication container 28 is depleted, or nears depletion, and the patient's prescription calls for continued infusion, the patient's care might be jeopardized unless a replenishment medication container 28 is available when needed. In order to help ensure that a replenishment medication container 28 is available, the fluid monitoring device 100 automatically communicates with a pharmacy, such as by an alert, with an appropriate lead-time to prepare and deliver the replenishment medication container 28. In certain embodiments, the alert may be a visual alert, which is advantageous in situations such as, for example, a pharmacist viewing a display device 102 in a pharmacy that lists all infusions occurring in the healthcare facility and is required to review numerous entries to find a particular infusion that requires urgent attention. In certain embodiments, in a situation where several instances of the same type of medication container 28 need to be prepared (e.g., several IVs of the same medication), an alert or other indication may be provided by the fluid monitoring device 100 to a user responsible for preparing the medication containers 28 notifying the user that several medication containers 28 of the same type need to be prepared, so that the user can prepare the medication containers 28 together, thereby improving efficiency. In certain embodiments, an alert can be issued if the medication container 28 satisfies a predetermined characteristic.

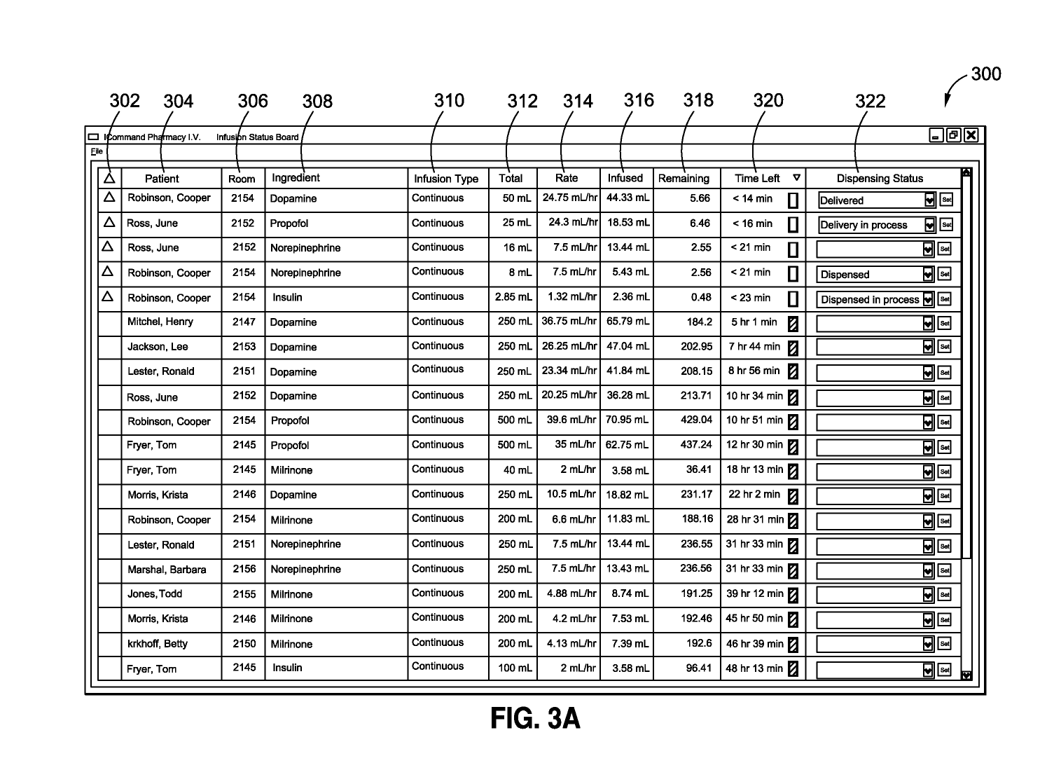

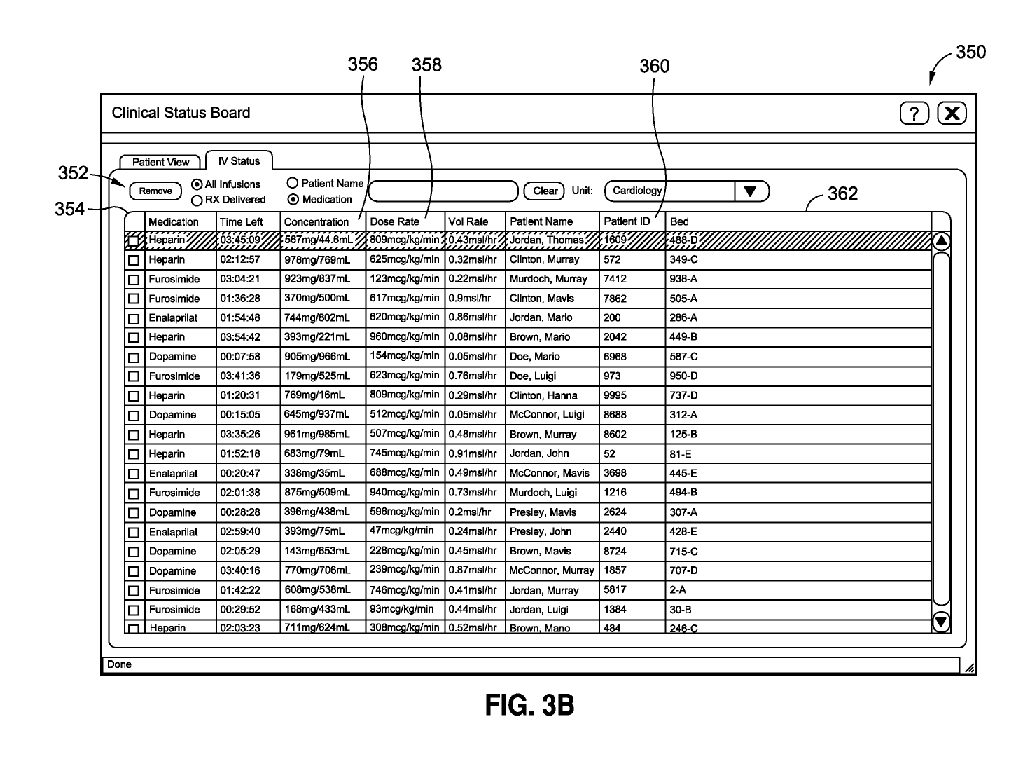

To determine if the processor 110 that calculated the approximate time of depletion should provide an alert signal of imminent depletion to the pharmacy, the time remaining before imminent depletion must be compared to the lead-time threshold value. If the time remaining meets that lead-time threshold, the processor 110 provides the alert signal. Lead-time thresholds may be determined on a medication-by-medication basis, and on the basis of the resources and capabilities of the pharmacy. Some medications may require a longer time for preparation than others. In some cases, a short time is required because it is just a mater of retrieving a pre-prepared medication from supply. However, in other cases, a substantial lead-time may actually be necessary to prepare medication. A database maybe prepared based on the above. Also considered in such a database may be the distance of the pharmacy from the patient requiring replenishment medication. Various additional factors may also be considered, such as the availability of transport that day, or the timing of transport for the medication to the patient. In any case, once the alert signal is provided, the display device 102 will present such information, as will be discussed below with reference to FIG. 3A.

The information provided on the display device 102 of the fluid monitoring system can be shown in a central pharmacy, satellite pharmacies, or wherever the admixture of IV infusions occur. The displayed information would allow the pharmacist to view the status of all infusions including the amount of solution left to be infused. The infusions that are near their end can be prioritized in a list to be viewed on the display device 102. This would allow the distributional pharmacist to prepare infusions just before they need to be sent to the floor and onto the patient 20. Based on the distributional system of the hospital, the next or replacement IV medication container 28 can be sent to the nursing unit before it needs to be administered to the patient 20. This obviates the need for the nurse to call the pharmacy when he/she needs the next IV medication container 28.

For example, the fluid monitoring device 100 streamlines the re-order process between the nurse and the pharmacy by allowing the distributional pharmacist to visualize medication containers 28 that are nearing completion, as illustrated in FIGS. 3A-5, which provide sample screenshots of the display device 102. Each of the interfaces disclosed herein may be configurable into different views, such as by moving one portion of the data in a first area of the interface to another area of the interface. The interfaces may also be configured according to the needs of the user, e.g., a clinical pharmacist view, a staff pharmacist view, and a nurse view. The views that include information on medications may include cross-functional views, graphical views, and data views of current, long-term, and short-term historical status for medications, such as IVs, syringes, and PCA infusions.

FIGS. 3A-3B are sample screenshots of medication status interfaces 300 and 350 according to certain embodiments, which may be viewable at a location such as a pharmacy. The screenshot 300 of FIG. 3A includes a column for alerts 302, patient names 304, patient room numbers 306, ingredient(s) or drug name(s) 308 contained in the medication container 28 being infused to the patient 20, infusion type 310, total volume 312 of the medication container 28, volume rate 314 of infusion, amount 316 of medication infused, amount 318 of medication remaining to be infused, time remaining 320 before the medication container 28 is about empty, and dispensing status 322. In each of the interfaces disclosed herein having columns, the columns may be movable or sortable. Note that all names are fictitious, and do not represent actual individuals.

The alerts column 302 displays a higher priority status for an infusion that is being alerted than the other infusions. Displays of alerted infusions may take various forms. In the illustrated embodiment, the alerted infusions are indicated by a danger icon 302 on the left side of the screen. In certain embodiments, the alerted infusion may separately or additionally be placed in a popup box on the display in a separate section of the screen or alerted infusions may simply overlay other information on the screen until minimized or moved. The alerted infusions may be displayed in a different color, different font, they may blink, they may move to the top of a list, or they may be shown on a second display designated for alerted infusions. Other arrangements for prioritizing alerted infusions are possible.

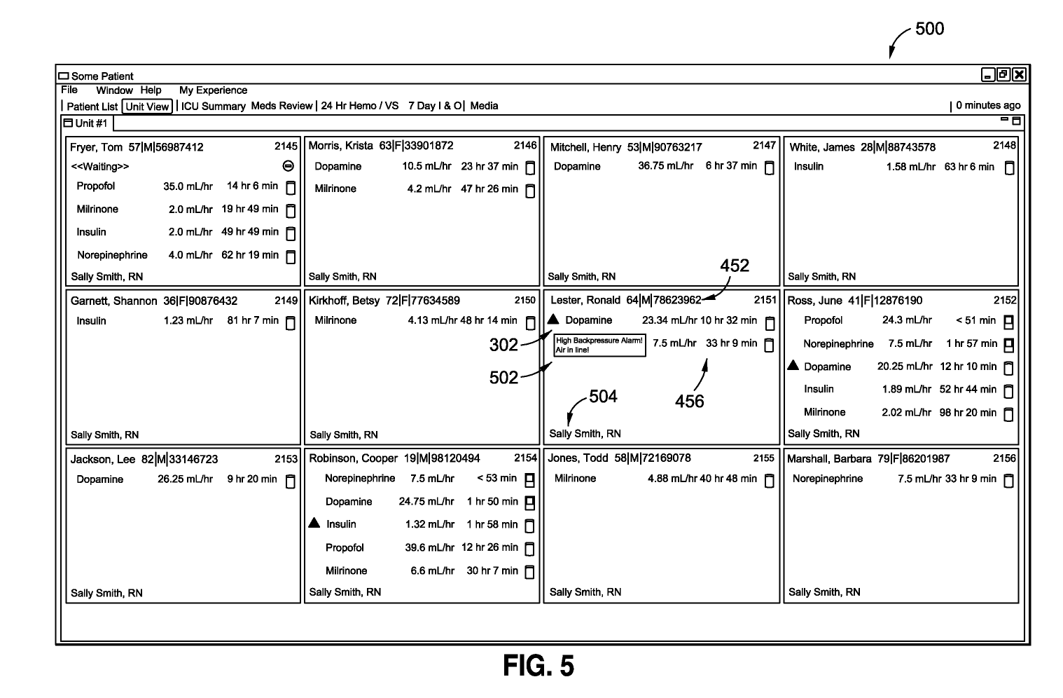

Additionally, if an alerted infusion has the inherent characteristic that requires approval before preparation of the replenishment container 28, additional lead-time may be added for an alert status. For example, for a particularly expensive infusion, the pharmacy would be alerted that this particular medication requires approval of the clinician, nurse, or physician, before replenishment can occur. This is because the patient may have been released by the healthcare facility and the replenishment medication is no longer needed. In such a case, the pharmacy may communicate with the nurse to obtain specific approval to begin preparation of the replenishment medication. In another case, the nurse station interface (500 in FIG. 5) may include the same indication of the inherent characteristic of the medication that makes an approval necessary, and can independently provide an indication to the pharmacy that the approval is given or not given.

The patient names 304 information provides the name of the patient and the patient room numbers 306 information provides the room location of the patient. The infusion type 310 information displays the type of infusion given to the patient, such as a continuous infusion. The information on patient names 304 and patient room numbers 306 may be obtained from the patient information 22 in the memory 16 of the PCU 10. The information on ingredient(s) 308 contained in the medication container 28 being infused to the patient 20, infusion type 310, total volume 312 of the medication container 28, rate 314 of infusion, amount 316 of medication infused, and amount 318 of medication remaining to be infused may be obtained from the medication container information 24 in the memory 16 of the PCU 10.

Also provided in the screenshot is a dispensing status 322 of the medication container 28 for the patient 20, if relevant. The dispensing status 322 is selected by a user, for example, once the medication container 28 has been prepared by the pharmacy. The dispensing status can include values indicating (1) a medication container 28 be prepared, which may be a default value, (2) a medication container 28 be discontinued, such as by designation of a physician, pharmacist, or nurse, (3) a medication container 28 is out for delivery and/or removed from pharmacy view, and (4) preparation of a medication container 28 is on hold, such as where the pharmacy is waiting for nurse verification.

FIG. 3B is a sample screenshot of a medication status interface 350 according to another embodiment. The medication status interface 350 includes a filtering module 352 that allows a user to remove, from the list of patients, information relating to patients 28 based on whether their medication container 28 has been delivered, their name, medication, or unit. In certain embodiments, other parameters may be used. The medication status interface 350 also includes a parameter 354 for directly selecting a medication container 28 status to remove from the list of medication containers.

The medication status interface 350 further includes information on the concentration 356 of the medication container 28 and the dose rate 358 of the medication container 28, both of which may be obtained from the medication container information 24 in the memory 16 of the PCU 10. The medication status interface 350 also includes patient identification number information 360, such as patients' medical record numbers, and the patients' bed numbers 362, each of which may be obtained from the patient information 22 in the memory 16 of the PCU 10. The interface 350 may be displayed on display device 102, in the pharmacy, for example.

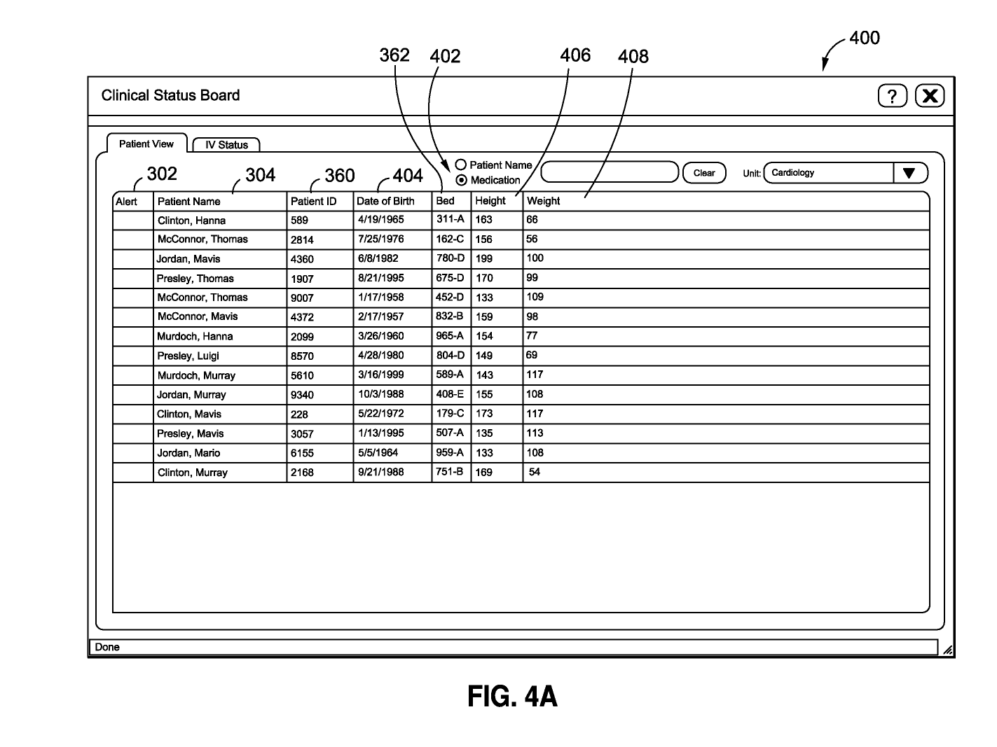

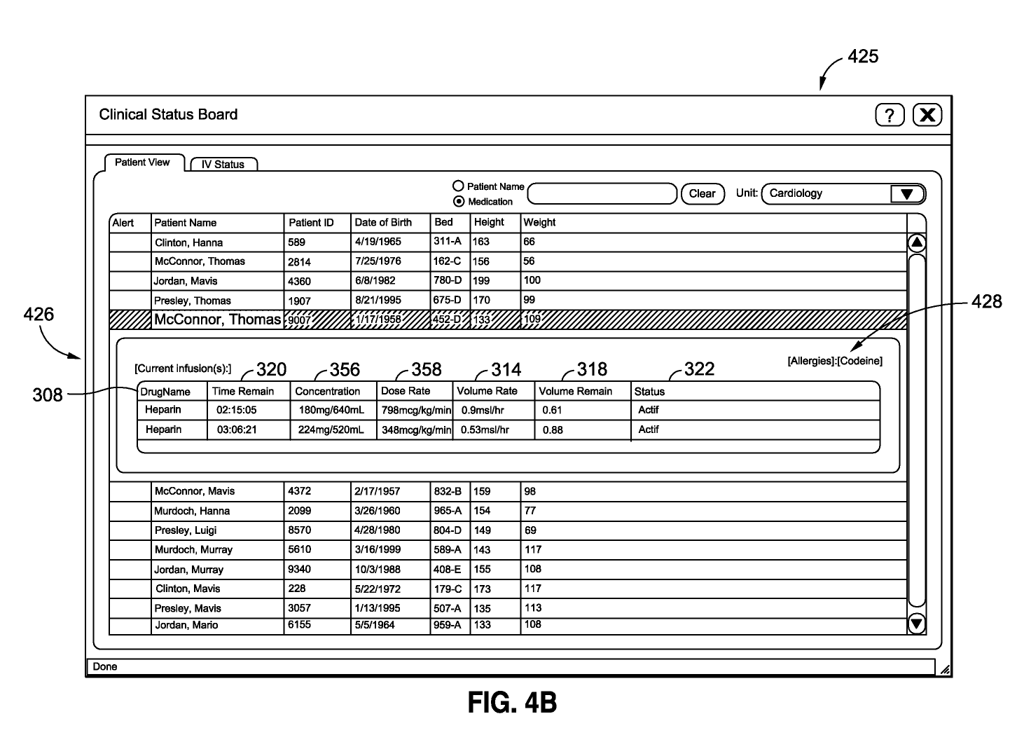

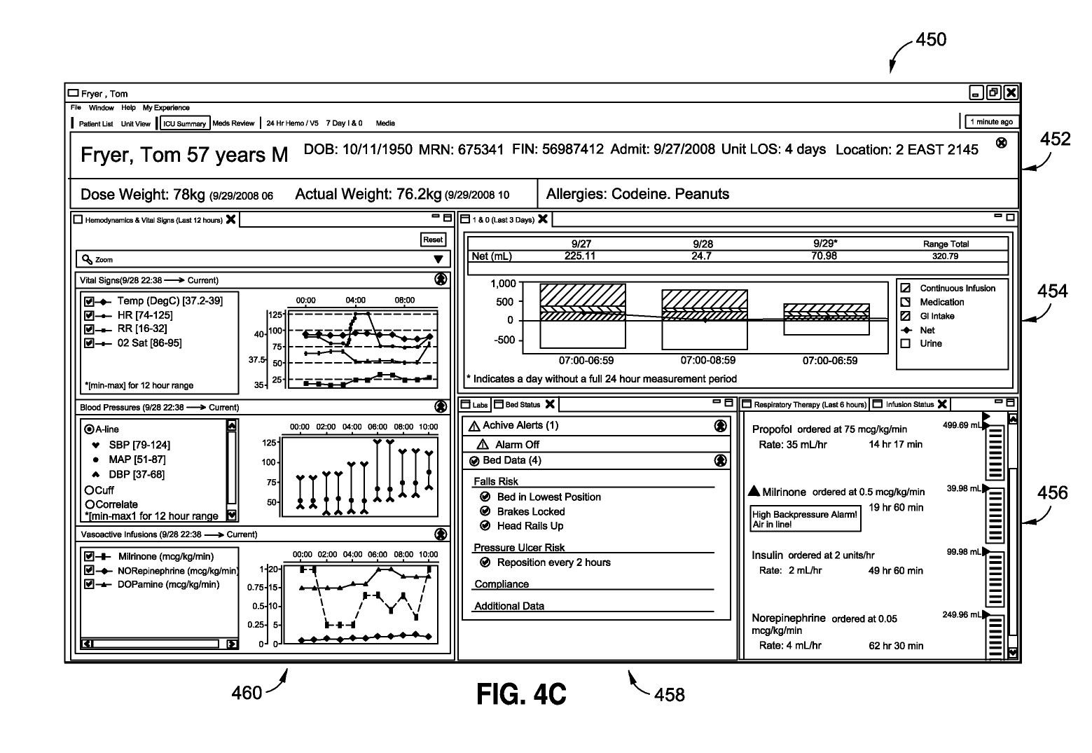

FIGS. 4A-4C are sample screenshots of patient information interfaces according to certain embodiments. The patient information interfaces 400, 425 and 450 differ from the medication status interfaces 300 and 350 in that the patient information interfaces 400, 425 and 450 are directed to displaying information about the patients 20 receiving medication from medication containers 28, and not the details of the medication being received. For example, the patient information interface 400 includes the column for alerts 302, patient names 304, patient identification number information 360, patient date of birth 404, patient bed number 362, patient height 406, and patient weight 408, but does not display details of the medication container 28 being infused. This information associated with patients 20 may be obtained from the patient information 22 in the memory 16 of the PCU 10. Also provided is a filtering interface 402 for selecting which patients 20 in the patient list to display, based on parameters such as patient name, medication, and unit. In certain embodiments, other parameters may be used.

Upon selecting a patient 20 from the list, additional information 426 can be displayed, as illustrated in the patient information interface 425 of FIG. 4B. The additional information 426 includes details of the medication(s) being received by the patient 20. Such additional information includes the ingredient(s) or drug name(s) 308 contained in the medication container 28 being infused to the patient 20, time remaining 320 before the medication container 28 is about empty, concentration 356 of the medication container 28 and dose rate 358 of the medication container 28, volume rate 314 of infusion, amount 318 of medication remaining to be infused, dispensing status 322, and patient allergies 428.

FIG. 4C illustrates an alternative patient information interface 450 that displays detailed information associated with a particular patient after that patient is selected from the patient list of the patient information interface 400 of FIG. 4A.

The patient information interface 450 includes detailed information 452 on the patient, such as the patient's name, date of birth, medical record number (“MRN”), federal identification number (“FIN”), date of admittance, length of stay (“LOS”), and location. The detailed information 452 on the patient displayed on the patient information interface 450 can be obtained from the patient information 22 in the memory 16 of the PCU 10. The patient information interface 450 also includes input and output information 454 tracking the input of the patient (e.g., from infusion, medication, and gastrointestinal intake) and output of the patient (e.g., urine). The patient information interface 450 further includes information 456 on the patient's infusion status (e.g., medication infusion status information), and information 458 on the patient's bed status (e.g., its position, need for repositioning, compliance, alerts). Other information 460 may be displayed on the patient information interface 450, such as hemodynamics and vital sign information, information provided by an infusion pump, a syringe pump, a PCA pump, an epidural pump, an enteral pump, a blood pressure monitor, a pulse oximeter, an EKG monitor, an EEG monitor, SpO2 monitor, EtCO2 monitor, respiration monitor, a heart rate monitor or an intracranial pressure monitor, or the like.

The information provided on the display device 102 of the fluid monitoring system can also be shown in patient care areas of the hospital to allow nurses to check status of one or many infusions from a central location, such as a nurse station. FIG. 5 is a sample screenshot of a nurse station interface 500 according to certain embodiments. The nurse station interface 500 provides fluid monitoring status information for many patients 20, and includes information on the nurse 504 responsible for each of the patients 20. Also included, for each patient, is the patient's detailed information 452, the status 456 of medications currently being administered to the patient 20, and, if relevant, both a general alert 302 for the patient and a pop-up specific alert 502 for the patient. The specific alert 502 provides information regarding the purpose of the alert 502 for the patient 20. The nurse station interface 500 can also include buttons or other options to allow the nurse to notify a pharmacy to reorder, hold, or discontinue a medication container 28 that is nearly empty. The nurse station interface 500 can also include an alert to notify the nurse when a replacement medication container 28 is ready, such as to be picked up from the pharmacy.

Other information may be displayed on one or any of the disclosed interfaces in addition to the information disclosed. For example, an application launcher (e.g., to launch applications that assist the user with the patient and/or medication), lab information, a drug library, task scheduler, communication module (e.g., a chat window), clinician notes, shift notes, flow sheet (e.g., infusion events, vitals, trending, future events), blood glucose information for insulin infusions, and pending orders.

Various additional features in addition to those discussed above are provided by the fluid monitoring device 100. The fluid monitoring device 100 is configured to allow a user to control the infusion of medication in the medication container 28 over the network 135 via the communications module 112 of the fluid monitoring device 100, communications module 18 of the point of care unit 10, and the processor 14 of the point of care unit 10. For example, if several fluid monitoring devices 100 are connected to the network 135, users of those devices, such as a pharmacist, a nurse, a physician, or a biomedical technician may view the information on their display device 102 and may use their fluid monitoring device 100 to both monitor the operation of the PCU 10 and/or adjust the therapy being provided to the patient by the PCU 10.

In certain embodiments, the fluid monitoring device 100 is configured to allow a user, such as a pharmacist, to communicate with users of other devices on the network 135, such as a nurse or another pharmacist. For example, a nurse can notify a pharmacist that another replacement medication container 28 will not be needed. In certain embodiments, the fluid monitoring device 100 is configured to allow various infusion status and historical reports to be printed at the printer 200, such as IV flow sheets, reorder lists, and IV therapy information.

In certain embodiments, the fluid monitoring device 100 allows a pharmacist or other user to electronically indicate medication containers 28 that will not require monitoring. This allows the display device 102 to select to display status information for certain medication containers 28 thus indicated, thereby reducing confusion by not displaying those medication containers 28 that do not require monitoring. For example, medication containers 28 that are not replenished by the pharmacy may not require tracking, such as medication containers 28 stored in a medication station, nursing unit, or that are otherwise premixed. By way of another example, medication containers 28 for which the user's pharmacy is not responsible may also not be tracked, so as to avoid having multiple pharmacies dispense the same kind of medication container 28 in a multiple pharmacy setting. In such cases, each pharmacy may also have different requirements for a lead-time, and are therefore able to designate how soon before end of infusion the IV would appear on the screen. Each pharmacy is able to designate a default lead-time that can be over-ridden to specify a unique lead-time for any given IV. Lead-times should also be specific to each care area, e.g. an intensive care unit would be one hour while a step-down unit would be two hours.

The embodiments of the present disclosure provide a fluid monitoring device that is configured to monitor a patient's present infusion status and automatically alert a pharmacy in a healthcare facility to replenish medications prior to the need for delivery of the next medication to the patient to begin.

The embodiments of the present disclosure will provide benefits to staff pharmacists, clinical pharmacists, and nurses. The devices and methods disclosed herein allow staff pharmacists to manage day to day workflow in pharmacies, anticipate medication needs, connect filled orders with bedside administration, better communicate with nurses, speed delivery of medication, reduce gaps in the process delivery, and provide better insight into the delivery process. The devices and methods disclosed herein will allow clinical pharmacists to simultaneously monitor the medication infusion status of many patients on the floor, prioritize high-risk drugs and/or high impact drugs, retrieve information on demand, and be informed of changing conditions. The devices and methods disclosed herein will allow nurses to see patients regularly, respond immediately to unexpected occurrences at the patient bedside, avoid forgetting to place orders for replacement medication, and provide increased focus on the patient, and less focus on the medication for the patient.

Although the term “processor” is used in various places in the description of preferred embodiments, such term is meant to apply to one or more devices that perform processing and is not necessarily limited to a single device located at one location. The term “processor” may include multiple processing devices located at locations separate from each other. A processor may be a general-purpose microprocessor, a microcontroller, a digital signal processor (“DSP”), an application specific integrated circuit (“ASIC”), a field programmable gate array (“FPGA”), a programmable logic device (“PLD”), a controller, a state machine, gated logic, discrete hardware components, or any other suitable device that can perform calculations or other manipulations of information. A processor may also include one or more machine-readable media for storing software. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media may include storage integrated into a processor, such as might be the case with an ASIC. Machine-readable media may also include storage external to a processor, such as a random access memory (“RAM”), a flash memory, a read only memory (“ROM”), a programmable read-only memory (“PROM”), an erasable PROM (“EPROM”), registers, a hard disk, a removable disk, a CD-ROM, a DVD, or any other suitable storage device. In addition, machine-readable media may include a transmission line or a carrier wave that encodes a data signal. Those skilled in the art will recognize how best to implement the described functionality for a processor. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. Instructions can be, for example, a computer program including code. A machine-readable medium may comprise one or more media. Furthermore, “medication” is not meant to be restrictive but is meant to include any fluids administered to a patient.

Computer program code for carrying out operations as discussed above can be written in an object oriented programming language such as, for example, JAVA™, Smalltalk, or C++. However, the computer program code for carrying out operations may also be written in conventional procedural programming languages, such as the “C” programming language, in an interpreted scripting language, such as Perl, or in a functional (or fourth generation) programming language such as Lisp, SML, Forth, or the like. The software may also be written to be compatible with HLA-7 requirements.

It is understood that although the present disclosure has been described in embodiments, various modifications of the illustrative embodiments, as well as additional embodiments of the disclosure, will be apparent to persons skilled in the art upon reference to this description without departing from the scope of the disclosure, as recited in the claims appended hereto. It is contemplated that the appended claims will cover any such modifications or embodiments as fall within the scope of the disclosure.

What is claimed is:

1. A fluid medication delivery monitoring device comprising:
a memory configured to receive volume information indicating a volume of fluid medication in a container;
a processor configured to determine a time remaining value indicating an approximate amount of time remaining until the dispensable volume of fluid medication in the container reaches about zero, and configured to compare the determined time remaining value to a lead-time threshold to prepare a replacement container with a volume of fluid medication; and
a display device configured to display a status of the container, the status comprising the time remaining value and a description of the fluid medication in the container.

2. The device of claim 1, wherein the display device is in a remote location from the container.

3. The device of claim 2, wherein the remote location is a pharmacy.

4. The device of claim 1, wherein the processor is further configured to compare the determined time remaining value to a lead-time threshold, and wherein the display device is configured to display an alert if the determined time remaining value is less than or about equal to the lead-time threshold.

5. The device of claim 4,
wherein the memory is further configured to receive second volume information indicating a volume of fluid medication in another container, and to receive second rate information indicating a rate of reduction of the volume of fluid medication in the other container,
wherein the processor is further configured to determine another time remaining value indicating an approximate amount of time remaining until the volume of fluid medication in the other container reaches about zero, and configured to compare the other determined time remaining value to another lead-time threshold, and
wherein the display device is further configured to display another status, the other status comprising the other time remaining value and a description of the fluid medication in the other container, and the display device further configured to display another alert if the other determined time remaining value is less than or about equal to the other lead-time threshold.

6. The device of claim 5, wherein the display device prioritizes the display of the status and the other status based on the time remaining value and the other time remaining value.

7. The device of claim 5, wherein the display device prioritizes the display of the alert and the other alert based on at least two of the time remaining value, the lead-time threshold, the other time remaining value, and the other lead-time threshold.

8. The device of claim 7, wherein the prioritization comprises using a plurality of visual display attributes.

9. The device of claim 1, wherein the processor is further configured to determine whether the fluid medication includes a predetermined characteristic, and if the fluid medication does include the predetermined characteristic, the display device is configured to display an indicator.

10. The device of claim 1, further comprising an output device configured to output a label comprising an identifier of the fluid medication in the container.

11. The device of claim 1, wherein the label comprises a bar code.

12. The device of claim 1, wherein the output device comprises an RFID encoder, and the label comprises and RFID.

13. The device of claim 1, wherein the lead-time threshold is based upon at least one of an estimated amount of time to prepare another container containing the fluid medication, an estimated amount of time to deliver the other container to a current location of the container, and an estimated amount of time to replace the container with the other container.

14. A method for monitoring fluid medication delivery, comprising:
receiving volume information indicating a dispensable volume of fluid medication in a container;
determining a time remaining value indicating an approximate amount of time remaining until the volume of fluid medication in the container reaches about zero;
comparing the determined time remaining value to a lead-time threshold to prepare a replacement container with a volume of fluid medication; and
displaying a status of the container, the status comprising the time remaining value and a description of the fluid medication in the container.

15. The method of claim 14, further comprising:
comparing the determined time remaining value to the lead-time threshold; and
displaying an alert if the determined time remaining value is less than or about equal to the lead-time threshold.

16. The method of claim 15, further comprising:
receiving second volume information indicating a volume of fluid medication in another container;
receiving second rate information indicating a rate of reduction of the volume of fluid medication in the other container;
determining another time remaining value indicating an approximate amount of time remaining until the volume of fluid medication in the other container reaches about zero;
comparing the other determined time remaining value to another lead-time threshold to prepare another replacement container with a volume of fluid medication; and
displaying another status, the other status comprising the other time remaining value and a description of the fluid medication in the other container; and
displaying another alert if the other determined time remaining value is less than or about equal to the other lead-time threshold.

17. The method of claim 16, further comprising prioritizing the display of the status and the other status based on the time remaining value and the other time remaining value.

18. The method of claim 17, wherein the prioritizing the display of the alert and the other alert is based on at least two of the time remaining value, the lead-time threshold, the other time remaining value, and the other lead-time threshold.

19. A fluid medication delivery monitoring device comprising:
a memory configured to receive volume information indicating a volume of fluid medication in a container;
a processor configured to determine a time remaining value indicating an approximate amount of time remaining until the dispensable volume of fluid medication in the container reaches about zero, and configured to compare the determined time remaining value to a lead-time threshold to prepare a replacement container with a volume of fluid medication;
a display device configured to display a status of the container, the status comprising the time remaining value and a description of the fluid medication in the container; and
an output device configured to generate a print command configured to cause a printer to generate a medication label, and further configured to generate an alert indicating a need for the replacement of the container within the lead-time threshold.

20. The device of claim 19, wherein the medication label comprises an identifier of the medication in the container.
